(19) United States
(12) Patent Application Publication
(10) Pub. No.: US 2011/0183030 A1
(43) Pub. Date: Jul. 28, 2011

(54) Hot-Runner System having Nano-Structured Material

(75) Inventors: Manon Belzile, Fairfield, VT (US); John Knapp, Jeffersonville, VT (US); Patrice Fabien Gaillard, Milton, VT (US); Edward Joseph Jenko, Essex, VT (US); Abdeslam Bouti, Swanton, VT (US); Paul Blais, South Burlington, VT (US)

(73) Assignee: HUSKY INJECTION MOLDING SYSTEMS LTD., Bolton (CA)

(21) Appl. No.: 13/121,690

(22) PCT Filed: Dec. 10, 2009
(86) PCT No.: PCT/US2009/067473

§ 371 Date: Mar. 30, 2011

Related U.S. Application Data
(60) Provisional application No. 61/140,172, filed on Dec. 23, 2008.

(51) Int. Cl. B29C 45/74; B29C 45/03

(52) U.S. Cl. 425/547; 425/542

(57) ABSTRACT

Disclosed is a hot-runner system of an injection molding system, the hot-runner system comprising a hot-runner component, including: a material, and a nano-structured material being combined with the material.

### TECHNICAL FIELD

The present invention generally relates to hot-runner systems of injection-molding systems, and more specifically the present invention relates to a hot-runner system of an injection-molding system, in which the hot-runner system has a hot-runner component that includes a nano-structured material having nano-particles.

### BACKGROUND

Examples of known molding systems are (amongst others): (i) the HYPET (TRADEMARK) Molding System, (ii) the QUADLOC (TRADEMARK) Molding System, (iii) the HYLECTRIC (TRADEMARK) Molding System, and (iv) the HYMET (TRADEMARK) Molding System, all manufactured by Husky Injection Molding Systems (Location: Canada; Web Site: www.husky.ca).

Examples of manufactures of nano-structured materials are: Integran located in Canada (telephone 416-675-6266), (ii) Northern Nanotechnologies Inc. located in Canada (telephone 416-260-8889). A company that licenses nano-materials and/or coatings is C3 International located in U.S.A. (telephone 678-624-0230). An example of an academic facility that studies nanotechnology is the Birck Nanotechnology Center of Purdue University, located in U.S.A. (telephone 765-494-7053). Examples of research organizations involved in the research of nanotechnology are: (i) National Nanotechnology Infrastructure Network (NNIN), (ii) Nano Science and Technology Institute (NSTI) located in U.S.A. (telephone 508-357-2925), and (iii) Polytech & Net GmbH located in Germany (telephone: +49 (0)6196-8845027). Organizations providing news and information about nanotechnology may be found at the following web sites: (i) www.azonano.com, (ii) www.nanotech-now.com, (iii) www.nanowerk.com and (iv) www.nanohub.org.

U.S. Pat. No. 6,164,954 (Inventor: MORTAZAVI et al.: Publication Date: Dec. 26, 2000) discloses an injection nozzle apparatus that comprises inner and outer body portions. The inner body portion includes a melt channel and the outer body is made of a pressure resistant material. The ratio between the inner diameter of the outer body portion and the outer diameter of the inner body portion is selected so that a pre-load or a load is generated when assembling the outer body over the inner body. Preferably the assemble of the two bodies is removably fastened to an injection nozzle body. Preferably the inner body comprises a material with wear resistant characteristics to withstand abrasive or corrosive molten materials. The apparatus of the present invention is particularly useful in molding machines and hot runner nozzles for high pressure molding of various materials at normal or elevated injection temperatures.

United States Patent Application Number 2003/0145973 (Inventor: GELLERT et al.: Publication Date: Aug. 7, 2003) discloses improved heated manifolds, heaters and nozzles for injection molding, having a high strength metal skeleton infiltrated with a second phase metal having higher thermal conductivity. Also disclosed is method of forming a manifold, heater or nozzle preform and infiltrating the preform with a highly thermally conductive material. The invention also provides a method of simultaneously infiltrating and brazing injection molding components of similar or dissimilar materials together.

U.S. Pat. No. 7,134,868 (Inventor: GUENTHER et al.: Publication Date: Nov. 14, 2006) discloses an injection molding nozzle with a tip portion in the gate area of the mold that has a wear-resistant diamond-type coating. The surface of the tip melt channel that delivers melt to the gate area may also comprise a diamond-type coating. Nozzle seal surfaces in the gate area may also comprise a diamond-type coating. The enhanced harness, smoothness and thermal conductivity of these coated surfaces results in higher quality molded parts, and easier to clean molding equipment that has a longer service life.

United States Patent Application Number 2008/0099176 (Inventor: CZERWINSKI; Publication Date: 2008 May 1) discloses a molding material handling component for a metal molding system that has a component body made from an alloy that is made contactable against molten metallic molding material including molten alloy of magnesium.

United States Patent Application Number 2006/0032243 (Inventor: GA-LANE CHEN; Published: 16 Feb. 2006) discloses an injection molding device, which includes an injection unit, a lock unit, and a control unit. The injection unit includes a mold and a cooling system. The cooling system includes one or more pipeways in the mold, and a coolant received in the pipeways. The coolant is a superfluid with carbon nanotubes suspended therein. A coefficient of viscosity of the superfluid is virtually zero, therefore friction between the superfluid and the nanotubes is extremely small. This enables the nanotubes in the superfluid in the pipeways to undergo more turbulent flow, so that the nanotubes can conduct more heat from the mold. In addition, the nanotubes themselves have high thermal conductivity. Accordingly, the thermal conductivity of the cooling system is enhanced. Thus, the molten material injected into the mold can be cooled and solidified fast. This provides the injection molding device with a high molding efficiency.

United States Patent Application Number 2008/0206391 (Inventor: BOUTI et al.; Publication Date: Aug. 28, 2008) discloses a nozzle assembly for an injection molding assembly has a nozzle housing having a melt channel extending therethrough, a nozzle tip, and a retainer that retains the nozzle tip against the nozzle housing. The nozzle tip is formed of a precipitation hardened, high thermal conductivity material and a precipitation hardened, high strength material, which are integrally joined together to form the body. The thermal conductivity of the high thermal conductivity material is greater than the thermal conductivity of the high strength material, and the strength of the high strength material is greater than the strength of the high thermal conductivity material. The high thermal conductivity material and the high strength material can be precipitation hardened together under the same precipitation hardening conditions to achieve increases in the value of at least one strength aspect of the high thermal conductivity material and the value of at least one strength aspect of the high strength material.

United States Patent Application Number US 2008/0274229 (Inventor: BARNETT; Filing Date: May 3, 2007) discloses a nozzle for an injection molding runner system where parts of the nozzle, and in particular the nozzle tip are made from a nanocrystalline material. Nanocrystalline materials used include nanocrystalline copper and nanocrystalline nickel, which have high thermal conductivity and increased material strength. A conventional form of the metal is worked till its grains are reduced in size to less than 100 nm to achieve the desired properties.

The current state of the art provides known hot-runners that are in many cases performance limited by material properties (such as, strength and thermal conductivity and/or wear resistance) associated with hot-runner components that include standard metal alloys, such as: PH13-8 (stainless-steel alloy), BeCu (beryllium copper alloy), 4140 (steel alloy), Aermet 100 (carbon bearing high strength alloy), H13 (tool and die steel alloy), etc.

### SUMMARY

In accordance with a generalized non-limiting embodiment of the present invention, there is provided a hot-runner system for use in an injection molding system, the hot-runner system comprises: a hot-runner component, which includes: a nano-structured material, and the nano-structured material includes nano-particles. A technical effect associated with the above embodiment, and other embodiments, is that incorporating the nano-structured material in the hot-runner component improves: (i) strength and/or longevity of the hot-runner component. State-of-the-art hot-runner components are limited by material properties having strength and wear resistance of standard metal alloys and coatings, etc. The nano-structured material can be (i) used as a base material for the hot-runner component, (ii) added to the hot-runner component by a deposition method, and/or (iii) coated to the hot-runner component.

### DETAILED DESCRIPTION OF THE NON-LIMITING EMBODIMENTS

Generally, a hot-runner system is used with an injection molding system; the hot-runner system includes hot-runner components (that are made with materials) that are known to persons skilled in the art, and these known components (and/or materials) will not be described here; these known components are described, at least in part, in the following reference books, for example: (i) “Injection Molding Handbook” authored by OSSWALD/TURNG/GRAMANN (ISBN: 3-446-21669-2), (ii) “Injection Molding Handbook” authored by ROSATO AND ROSATO (ISBN: 0-412-99381-3), (iii) “Injection Molding Systems” 3^{rd} Edition authored by JOHANNABER (ISBN 3-446-17733-7) and/or (iv) “Runner and Gating Design Handbook” authored by BEAUMONT (ISBN 1-446-22672-9).

### First Non-Limiting Embodiment

In accordance with the first non-limiting embodiment, the hot-runner system (for use in an injection molding system) includes (but is not limited to): a hot-runner component. The hot-runner component includes (but is not limited to): a nano-structured material. The nano-structured material includes (but is not limited to): nano-particles. In accordance with a variant of the first embodiment, the nano-particles include (but not limited to): metallic particles and/or ceramic particles, etc. In accordance with another variant of the first embodiment, the nano-particles include (but not limited to): spheroidized particles and/or non-spheroidized particles. In accordance with yet another variant of the first embodiment, the nano-particles include (but not limited to): metallic particles and/or ceramic particles and/or spheroidized particles and/or non-spheroidized particles.

### Second Non-Limiting Embodiment

In accordance with the second non-limiting embodiment, the hot-runner system (of the first embodiment) is modified such that the hot-runner component includes (but is not limited to): a material (such as, but not limited to, a metal alloy and/or a ceramic material), and the nano-structured material is combined, at least in part, with the material. The definition for “combined” is as follows: to put or bring or join together so as to form a unit, and/or to put or bring into close association or relationship, and/or to make or join or unite into one, and/or to come or bring into union, and/or to act or to mix together. In accordance with a non-limiting variant of the second embodiment, the material includes the metal alloy, and the nano-structured material is dispersed in the metal alloy, so that the metal alloy and the nano-structured material are combined to form to form a nano-structured metal composite. In accordance with another non-limiting variant of the second embodiment, the material includes the ceramic material, and the nano-structured material is dispersed in the ceramic material, so that the ceramic material and the nano-structured material are combined to form a nano-structured ceramic composite.

### Third Non-Limiting Embodiment

In accordance with the third non-limiting embodiment, the hot-runner system (of the first embodiment) is modified, such that the hot-runner component includes (but is not limited to): the material, and a coating surrounding, at least in part, the material, and the nano-structured material is combined, at least in part, with the coating. In accordance with a non-limiting variant of the third embodiment, the nano-structured material is dispersed, at least in part, in the coating, and the coating includes the metal alloy, so that the nano-structured material and the coating are combined to form a nano-structured metal coating. In accordance with another non-limiting variant of the third embodiment, the nano-structured material is dispersed, at least in part, in the coating, and the coating includes the ceramic material, so that the nano-structured material and the coating are combined to form a nano-structured ceramic coating.

### Fourth Non-Limiting Embodiment

The fourth non-limiting embodiment is a combination of the second embodiment and the third embodiment. In accordance with the fourth non-limiting embodiment, the hot-runner system (of the first embodiment) is modified, such that: the hot-runner component includes (but is not limited to): (A) the material, and the nano-structured material is combined, at least in part, with the material, and (B) the coating that surrounds, at least in part, the material, and the nano-structured material is combined, at least in part, in the coating.

### Hot-Runner Components

Examples of the hot-runner component that may include nano-structured material are (but not limited to): a nozzle tip, a nozzle housing, a manifold, a melt channel defined by the manifold, a bushing, a manifold bushing, a sprue bushing, a valve stem, a mold gate insert, a screw, a valve, a stem bushing, a mold slide, a piston cylinder, etc. The following is a list of the improvement in performance or longevity of selected hot-runner components: (i) higher strength (such as, but not limited to, nozzle tips, nozzle housings, manifolds, manifold bushings, sprue bushings), (ii) higher wear resistance (such as, but not limited to, nozzle tips, manifold bushings, stems, gate inserts, screws, valves).

### Nano-Structured Material (NsM)

The nano-structured material (NsM) may include, for example, (i) nano particles, which may be a metal-alloy particle or a ceramic particle, etc, being less than 1 micron in diameter, and the nano-structured material may be implemented as a material of a substrate or as a coating to a substrate. In addition, the nano-structured material may be implemented as a nano crystalline structure. A nano coating may include nano particles and/or a nano crystalline structure. The nano-structured material may sometimes be referred to as “nano-particles” or “nano-particle based material”. The nano-particle based material is a particle sized less than 1 micron. A technical advantage of the hot-runner component having a nano-structured material is that the hot-runner component has a fine structure having improved toughness (as a result of its small grain size), and/or improved uniform properties (i.e.: small round particles are nested together better than larger non-uniform particles). Small particles also have a much larger ratio of surface energy to their masses than larger particles, therefore increasing bond strength between particles. Spheroidization of nano-structured materials further enhances the above mentioned benefits, and may be generally obtained from induction plasma or pulsation reactors, amongst other methods. The nano-structured material can be obtained from nanosized particles but may also be obtained from larger particles that are mechanically and thermally impacted to create a nanosize structure. In the last two decades, a class of materials with a nanometer-sized microstructure have been synthesized and studied. These materials are assembled from nanometer-sized building blocks, mostly crystallites. The building blocks may differ in their atomic structure, crystallographic orientation, or chemical composition. In cases where the building blocks are crystallites, incoherent or coherent interfaces may be formed between them, depending on: (i) the atomic structure, (ii) the crystallographic orientation, and/or (iii) the chemical composition of adjacent crystallites. In other words, materials assembled of nanometer-sized building blocks are micro-structurally heterogeneous, including the building blocks (e.g. crystallites) and the regions between adjacent building blocks (e.g. grain boundaries). It is this inherently heterogeneous structure on a nanometer scale that is crucial for many of their properties and distinguishes them from glasses, gels, etc. that are micro-structurally homogeneous. Grain boundaries make up a major portion of the material at nanoscales, and strongly affect properties and processing. The properties of the NsM deviate from those of single crystals (or coarse grained polycrystals) and glasses with the same average chemical composition. This deviation results from the reduced size and dimensionality of the nanometer-sized crystallites as well as from the numerous interfaces between adjacent crystallites. In comparison to macro-scale powders, increased ductility has been observed in nano-powders of metal alloys.

### Nanosized Particle, Nanosized Spheroidized Particle, Nanosized Metal Powder

According to a non-limiting embodiment, the nano-structured material (NsM) includes nanosized particles, nanosized spheroidized particles and/or a nanosized metal powder, and/or a nanosized ceramic powder, for improving the mechanical properties of the hot-runner component.

### Nano-Based Coating

According to a non-limiting embodiment, the nano-structured material includes a nano-based coating. The nano-based coating tends to be more uniform and have improved adherence due to increased surface bonds between particles and with a substrate. Techniques for growing or depositing nano-structured materials are: as follows (but not limited to): (i) MBE (Molecular Beam Epitaxy), (ii) MOCVD (Metal Organic Chemical Vapor Deposition), (iii) PECVD (Plasma Enhanced Chemical Vapor Deposition), (iv) HVPE (Halide Vapor Phase Epitaxy), (v) PLD (Pulsed Laser Deposition), (vi) ALD (Atomic Layer Deposition), (vii) Sputtering. The hot-runner component may be coated with the nano-particle based material and/or may be made of the nano-particle based material.

### Nano-Based Metal Alloy

The nano-structured material may include a metal alloy (such as copper alloys, nickel alloys, steel alloys (including stainless), titanium alloys, aluminum alloys), a ceramic and/or a ceramic composite. The nano-structured material may be made from metal alloys available in powder form or transformed to nano-particle sizes.

### Manufacturing Process

The nano-structured material, which contains particles or “nano-particles”, may be manufactured by a process of: (i) sintering, (ii) 3D printing or (iii) powder injection molding, and/or (iv) other means of transforming fine powders into near net shape, raw material forms such as bar stock, rod or plates, or final net shapes. It is possible to create nanocrystalline materials from conventional materials by severe plastic deformation, which is a mechanical means of achieving those small grain sizes.

### Functional Grading

In accordance with a non-limiting embodiment, the nano-structured material is functionally graded through the hot-runner component so that a property of the hot-runner component is varied through the hot-runner component. In accordance with a variant of the above embodiment, the hot-runner component includes (but is not limited to): the coating, the nano-structured material being dispersed, at least in part, in the coating, the coating surrounding, at least in part, the hot-runner component, the nano-structured material being functionally graded through the coating so that a property of the hot-runner component is varied through the hot-runner component. In accordance with another variant of the above embodiment (which is a combination of the above identified embodiment and variant), the hot-runner component includes (but is not limited to): (A) the coating, in which the nano-structured material is dispersed, at least in part, in the coating, and the coating surrounds, at least in part, the hot-runner component, and the nano-structured material is functionally graded through the coating so that a property of the hot-runner component is varied through the hot-runner component, and (B) the nano-structured material is functionally graded through the hot-runner component so that another property of the hot-runner component is varied through the hot-runner component.

The description of the non-limiting embodiments provides non-limiting examples of the present invention; these non-limiting examples do not limit the scope of the claims of the present invention. The non-limiting embodiments described are within the scope of the claims of the present invention. The non-limiting embodiments described above may be: (i) adapted, modified and/or enhanced, as may be expected by persons skilled in the art, for specific conditions and/or functions, without departing from the scope of the claims herein, and/or (ii) further extended to a variety of other applications without departing from the scope of the claims herein. It is understood that the non-limiting embodiments illustrate the aspects of the present invention. Reference herein to details and description of the non-limiting embodiments is not intended to limit the scope of the claims of the present invention. Other non-limiting embodiments, which may not have been described above, may be within the scope of the appended claims. It is understood that: (i) the scope of the present invention is limited by the claims, (ii) the claims themselves recite those features regarded as essential to the present invention, and (ii) preferable embodiments of the present invention are the subject of dependent claims. Therefore, what is protected by way of letters patent is limited only by the scope of the following claims:

1. A hot-runner system for use in an injection molding system, the hot-runner system comprising:
a hot-runner component, including:
a nano-structured material, including:
nano-particles.

2. The hot-runner system of claim 1, wherein:
the nano-particles include:
metallic particles.

3. The hot-runner system of claim 1, wherein:
the nano-particles include:
ceramic particles.

4. The hot-runner system of claim 1, wherein:
the nano-particles include:
metallic particles; and
ceramic particles being combined with the metallic particles.

5. The hot-runner system of claim 1, wherein:
the nano-particles include:
spheroidized particles.

6. The hot-runner system of claim 1, wherein:
the nano-particles include:
non-spheroidized particles.

7. The hot-runner system of claim 1, wherein:
the nano-particles include:
spheroidized particles; and
non-spheroidized particles being combined with the spheroidized particles.

8. The hot-runner system of claim 1, wherein:
the hot-runner component includes:
a material, and the nano-structured material is combined, at least in part, with the material.

9. The hot-runner system of claim 8, wherein:
the material includes a metal alloy; and
the nano-structured material is dispersed in the metal alloy, so that the metal alloy and the nano-structured material are combined to form a nano-structured metal composite.

10. The hot-runner system of claim 8, wherein:
the material includes a ceramic material; and
the nano-structured material is dispersed in the ceramic material, so that the ceramic material and the nano-structured material are combined to form a nano-structured ceramic composite.

11. The hot-runner system of claim 1, wherein:
the hot-runner component includes:
a material; and
a coating surrounding, at least in part, the material, and the nano-structured material being combined, at least in part, in the coating.

12. The hot-runner system of claim 11, wherein:
the nano-structured material is dispersed, at least in part, in the coating, and the coating includes a metal alloy, so that the nano-structured material and the coating are combined to form a nano-structured metal coating.

13. The hot-runner system of claim 11, wherein:
the nano-structured material is dispersed, at least in part, in the coating, and the coating includes a ceramic material, so that the nano-structured material and the coating are combined to form a nano-structured ceramic coating.

14. The hot-runner system of claim 1, wherein:
the hot-runner component includes:
a material, and the nano-structured material is combined, at least in part, with the material; and
a coating surrounding, at least in part, the material, and the nano-structured material being combined, at least in part, in the coating.

15. The hot-runner system of claim 1, wherein:
the nano-structured material is functionally graded through the hot-runner component so that a property of the hot-runner component is varied through the hot-runner component.

16. The hot-runner system of claim 1, wherein:
the hot-runner component includes:
a coating, the nano-structured material being dispersed, at least in part, in the coating, the coating surrounding, at least in part, the hot-runner component, the nano-structured material being functionally graded through the coating so that a property of the hot-runner component is varied through the hot-runner component.

17. The hot-runner system of claim 1, wherein the hot-runner component includes:
a coating, the nano-structured material being dispersed, at least in part, in the coating, the coating surrounding, at least in part, the hot-runner component, the nano-structured material being functionally graded through the coating so that a property of the hot-runner component is varied through the hot-runner component, and
the nano-structured material being functionally graded through the hot-runner component so that another property of the hot-runner component is varied through the hot-runner component.

18. The hot-runner system of claim 1, wherein:
the hot-runner component includes any one of:
a nozzle tip,
a nozzle housing,
a manifold,
a melt channel defined by the manifold,
a bushing,
a manifold bushing,
a sprue bushing,
a valve stem,
a mold gate insert,
a valve,
a stem bushing,
a mold slide, and
a piston cylinder.

19. An injection molding system, comprising:
a hot-runner system, including:
a hot-runner component, including:
a nano-structured material, including:
nano-particles.
